(19) United States
(12) Patent Application Publication
(10) Pub. No.: US 2003/0145319 A1
(43) Pub. Date: Jul. 31, 2003

(54) Method and system for calculating viewing/listening status index of content delivered by streaming

(75) Inventor: Hiroaki Sato, Kawasaki (JP)

Correspondence Address: STAAS & HALSEY LLP, 700 11TH STREET, NW, SUITE 500, WASHINGTON, DC, 20001, US

(73) Assignee: FUJITSU LIMITED, Kawasaki (JP)

(21) Appl. No.: 10/200,160

(22) Filed: Jul. 23, 2002

(30) Foreign Application Priority Data
Jan. 30, 2002 (JP) 2002-022079

(51) Int. Cl. H04N 7/16; H04H 9/00

(52) U.S. Cl. 725/14; 725/20; 725/9; 725/29

(57) ABSTRACT

A method for calculating an audience rating in content delivery by streaming includes the steps of: reading out log information concerning a content delivered by streaming to be processed in log information with respect to a content delivery processing by streaming, which is carried out in accordance with an instruction from each user terminal; extracting information concerning a time change of an audience number of the content delivered by streaming to be processed; and calculating the audience rating on the basis of the extracted result. Since the information concerning the time change of the audience number is also extracted, it becomes possible to specify the peak of the audience number or the peak of the audience rating calculated from the audience number.

### TECHNICAL FIELD OF THE INVENTION

The present invention relates to a calculation technique of a viewing/listening status index, such as an audience rating or an audience number, in content delivery by streaming.

### BACKGROUND OF THE INVENTION

Today, blending of broadcasting and communication is advocated, and many broadcasting companies using the Internet start business development. In the case where the broadcasting company in the Internet carries on a business similar to the ground wave broadcasting, it is conceivable to adopt such a business model that both content and an advertisement are delivered to obtain advertisement revenue from a sponsor.

In the ground wave broadcasting, since there is an index, estimation of which has been established, that is, an audience rating of a program, the sponsor judges the propriety of provision of an advertisement, cost effectiveness, and the like on the basis of the audience rating. However, in the content delivery by streaming, it is common to use a count value of the total number of accesses to the content as an index indicating how many people viewed or listened it.

As stated above, in the content delivery by streaming through a computer network such as the Internet, there is no index other than the total number of accesses, which is not accurate, and the idea itself of the audience rating is not established. Thus, it is difficult for the sponsor to judge the propriety of advertisement provision and the cost effectiveness, and streaming delivery of a content with advertisement has not been realized in earnest.

Besides, since a time change of the audience rating can be specified in the ground wave broadcasting, a peak audience rating in a program can be specified. That is, since it is possible to specify which scene in the program most fascinates the audiences, it can be made as a reference for later creation of a program. However, in the case where viewing/listening times are different among users, such as in VOD (video on demand) in the Internet broadcasting, there does not exist a technique to specify the peak audience rating.

Further, in the ground wave broadcasting, an audience rating in each area can be specified, however, in the Internet broadcasting, there is also no technique to specify the audience rating in each area.

### SUMMARY OF THE INVENTION

In view of the above, an object of the present invention is to provide a technique for calculating an audience rating in content delivery by streaming.

Another object of the invention is to provide a technique for specifying a time change of an audience rating in content delivery by streaming.

Still another object of the invention is to provide a technique for calculating an audience rating in each area in content delivery by streaming.

A method for calculating a viewing/listening status index of a content delivered by streaming, according to the invention, comprises the steps of: reading out log information concerning a content delivered by streaming to be processed in log information stored in a storage device, with respect to a content delivery processing by streaming, which is carried out in accordance with an instruction from each user terminal; and extracting information concerning a time change of an audience number in the content delivered by streaming to be processed and storing the extracted result into the storage device.

By doing so, it becomes possible to acquire the information of the audience number required for calculation of an audience rating. Besides, since the information concerning the time change of the audience number can also be extracted, it becomes possible to specify the peak of the audience number or the peak of the audience rating calculated from the audience number.

Incidentally, in the present specification, the word “audience” includes any of persons who watch only video, persons who listen only audio, and persons who watch video and listen audio.

Besides, this invention may further comprise a step of calculating an audience rating using the information concerning the time change of the audience number in the content delivered by streaming to be processed and storing it into the storage device. For example, the audience rating can be calculated using the audience number and the total number of members. Besides, the time change of the audience rating can also be specified.

Further, the aforementioned extracting step may comprise a step of analyzing details (for example, fast forward, rewind, stop, etc.) of the content delivery processing by streaming, which is carried out in accordance with an instruction from each user terminal, and information concerning a time associated with the content delivery processing, and specifying a repeatedly delivered portion and a non-delivered portion to each user terminal in the content delivered by streaming to be processed. For example, with respect to the repeatedly delivered portion, the audience number is increased in accordance with the number of times of delivery, and with respect to the non-delivered portion, the number of times of delivery is made unchanged, so that an accurate time change of the audience number can be grasped.

Besides, the aforementioned extracting step may comprise a step of counting the audience number in each scene (for example, a time unit in the embodiment) arbitrarily defined with respect to the content delivered by streaming to be processed by using the read log information and storing it into the storage device. Since the scene can be arbitrarily defined, it need not be a scene according to the details of the content delivered by streaming, but may be defined in order to count the audience number. Besides, its length need not be uniform. Since a count is made for each scene, the structure becomes simpler than that of continuous counting. Besides, it becomes possible to judge which scene fascinates audiences. Especially, in the case of VOD, the audience can see the same scene again and again, and in such a case, it is conceivable that the audience number and the audience rating have a large value in that scene. That is, the scene fascinating the audiences can be more simply specified.

Further, the foregoing step of reading out log information may comprise a step of extracting log information with respect to a server for carrying out a delivery processing in a specific area. In the content delivery by streaming, in order to save a network bandwidth and to secure stream quality, a content relay function, that is, a local station is often disposed at a location near a client. Thus, if the log information in the local station is used, the audience number and the audience rating in each area can be calculated.

Besides, in the case where the content delivered by streaming to be processed is a live delivered content, the aforementioned extracting step may include a step of increasing the audience number for each scene from a scene including a viewing/listening start time to a scene including an viewing/listening end time in each log. By doing this, the live delivery can also be handled.

Further, in a case where the content delivered by streaming to be processed is a content in a demand delivering mode (for example, VOD), in the aforementioned extracting step, a repeatedly delivered portion or a non-delivered portion in the same scene to one user terminal may be left out of consideration in the audience number count of that scene. This is for simplifying the audience number count.

Besides, in a case where the content delivered by streaming to be processed is a content in a demand delivering mode, in the aforementioned extracting step, the audience number for all repeatedly delivered scenes may be increased by the number of times of delivery as for repeated delivery straddling scenes to one user terminal.

Further, the foregoing step of calculating an audience rating may comprise a step of calculating an average audience rating as to the content delivered by streaming to be processed and storing it into the storage device. By calculating the average audience rating, a comparison between contents becomes easy to carry out.

Incidentally, the foregoing method can be carried out through a program and a computer, and this program is stored in a storage medium or a storage device, for example, a flexible disk, a CD-ROM, a magneto-optical disk, a semiconductor memory, or a hard disk. Besides, there is also a case where the program is distributed through a network. Incidentally, an intermediate processing result is temporarily held in a memory.

### BRIEF DESCRIPTION OF THE DRAWINGS

FIG. 1 is a diagram for explaining a system outline of one embodiment of the present invention;

FIG. 2 is a diagram showing a processing flow of a preprocessing in one embodiment of the present invention;

FIG. 3 is a diagram showing an example (in the case of “Live”) of data stored in a content information DB;

FIG. 4 is a diagram showing an example (in the case of “Live”) of data stored in a member information DB;

FIG. 5 is a diagram showing an example (in the case of “Live”) of data stored in a location information DB;

FIG. 6 is a diagram showing an example (in the case of “Live”) of an audience number table stored in an audience rating information DB;

FIG. 7 is a diagram showing an example (in the case of “Live”) of an audience rating table stored in the audience rating information DB;

FIG. 8 is a diagram showing an example (in the case of “Live”) of data stored in a delivery log information DB;

FIG. 9 is a diagram showing an example of a main processing flow of one embodiment of the present invention;

FIG. 10 is a diagram showing a policy of live audience number count;

FIG. 11 is a diagram showing an example of a processing flow of a live audience number count processing;

FIG. 12 is a diagram showing a policy of VOD audience number count;

FIG. 13 is a diagram showing an example (in the case of “VOD”) of data stored in a delivery log information DB;

FIG. 14 is a diagram showing an example (in the case of “VOD”) of data stored in a content information DB;

FIG. 15 is a diagram showing an example (in the case of “VOD”) of data stored in a member information DB;

FIG. 16 is a diagram showing an example (in the case of “VOD”) of data stored in a location information DB;

FIG. 17 is a diagram showing an example (in the case of “VOD”) of an audience number table stored in an audience rating information DB;

FIG. 18 is a diagram showing an example (in the case of “VOD”) of an audience rating table stored in the audience rating information DB;

FIG. 19 is a diagram showing a first portion of a processing flow of a VOD audience number count processing; and

FIG. 20 is a diagram showing a second portion of a processing flow of the VOD audience number count processing.

### DETAIL DESCRIPTION OF THE PREFERRED EMBODIMENTS

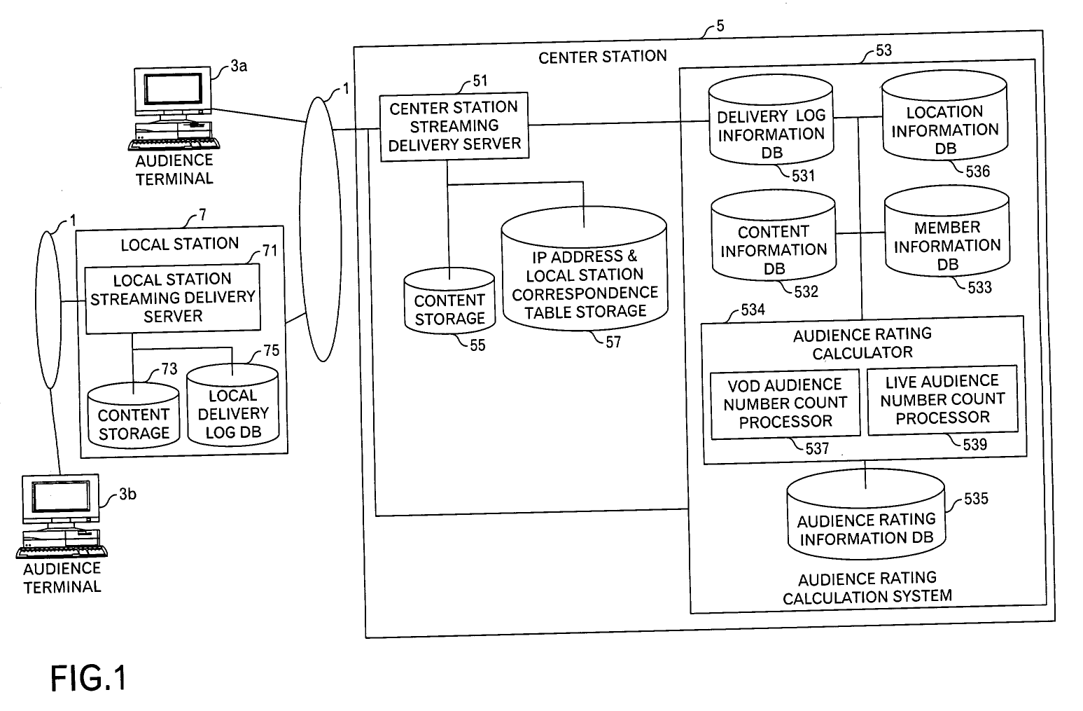

FIG. 1 shows a system outline of one embodiment of the present invention. A network 1, which is a computer network, such as the Internet, is connected with one or plural audience terminals 3, a center station 5, and one or plural local stations 7. The audience terminals 3 include one or plural audience terminals 3a receiving delivery of content from the center station 5, and one or plural audience terminals 3b receiving delivery of content from the local station 7. The audience terminal 3a and the audience terminal 3b are different from each other only in the delivery origin, and their functions are not particularly different from each other.

The center station 5 includes a center station streaming delivery server 51, and an audience rating calculation system 53. The center station streaming delivery server 51 is a server for delivering Live delivery content and VOD delivery content to the one or plural audience terminals 3a, and also distributes the Live delivery content to the local station 7. The center station streaming delivery server 51 manages a content storage 55 for storing content to be delivered, and an IP address & local station correspondence table storage 57 for storing an IP address & local station correspondence table indicating a correspondence relationship between an IP address of the audience terminal 3b receiving the delivery of content from the local station 7, not the center station streaming delivery server 51, and the local station 7 for actually carrying out the delivery. In the case where the audience terminal 3b, which ought to receive the delivery of content from the local station 7, accesses the center station streaming delivery server 51 and requests the delivery of content, the center station streaming delivery server 51 refers to the IP address & local station correspondence table to carry out a processing for switching so that the audience terminal 3b receives the delivery from the local station 7. Besides, the center station streaming delivery server 51 stores log information concerning content delivery to the audience terminal 3a by itself into a delivery log information DB 531 included in the audience rating calculation system 53.

The audience rating calculation system 53 includes the delivery log information DB 531 for storing the log information of content delivery performed by the center station streaming delivery server 51 and the log information of content delivery performed in the local station 7, a content information DB 532 for storing information concerning a total time, a delivery start time, a delivery end time of each content and so on, a location information DB 536 for storing a correspondence relationship between the local station 7 and its territory, a member information DB 533 for storing information of the total number of members, the number of members in each area, and the like, an audience rating calculator 534 for carrying out a processing using the information stored in the delivery log information DB 531, the content information DB 532, the location information DB 536, and the member information DB 533, and an audience rating information DB 535 for storing information of an audience number counted by the audience rating calculator 534 and an audience rating calculated by the audience rating calculator 534. The audience rating calculator 534 includes a VOD audience number count processor 537 for counting an audience number concerning VOD content, and a Live audience number count processor 539 for counting an audience number concerning Live content.

The local station 7 includes a local station streaming delivery server 71. The local station streaming delivery server 71 is a server for delivering Live delivery content and VOD delivery content to one or plural audience terminals 3b, similarly to the center station streaming delivery server 51. In the case of the live delivery content, as stated above, the local station 7 receives the content delivery from the center station streaming delivery server 51 and relays it to the audience terminal 3b. The local station streaming delivery server 71 manages a content storage 73 for storing content to be delivered and a local delivery log DB 75 for storing log information concerning content delivery to the audience terminal 3b by itself. That is, the local station streaming delivery server 71 delivers the content stored in the content storage 73 by streaming to the audience terminal 3b. When the delivery processing is carried out, the log information is stored in the local delivery log DB 75. Besides, the local station 7 transmits the log information stored in the local delivery log DB 75 to the audience rating calculation system 53 periodically or at an arbitrary timing. The audience rating calculation system 53 receives and stores the log information transmitted from the local station 7 into the delivery log information DB 531.

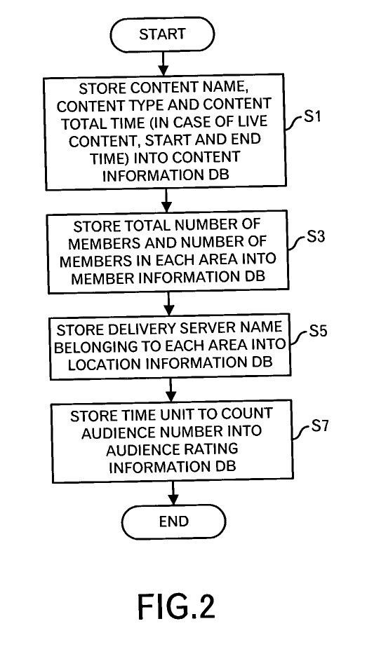

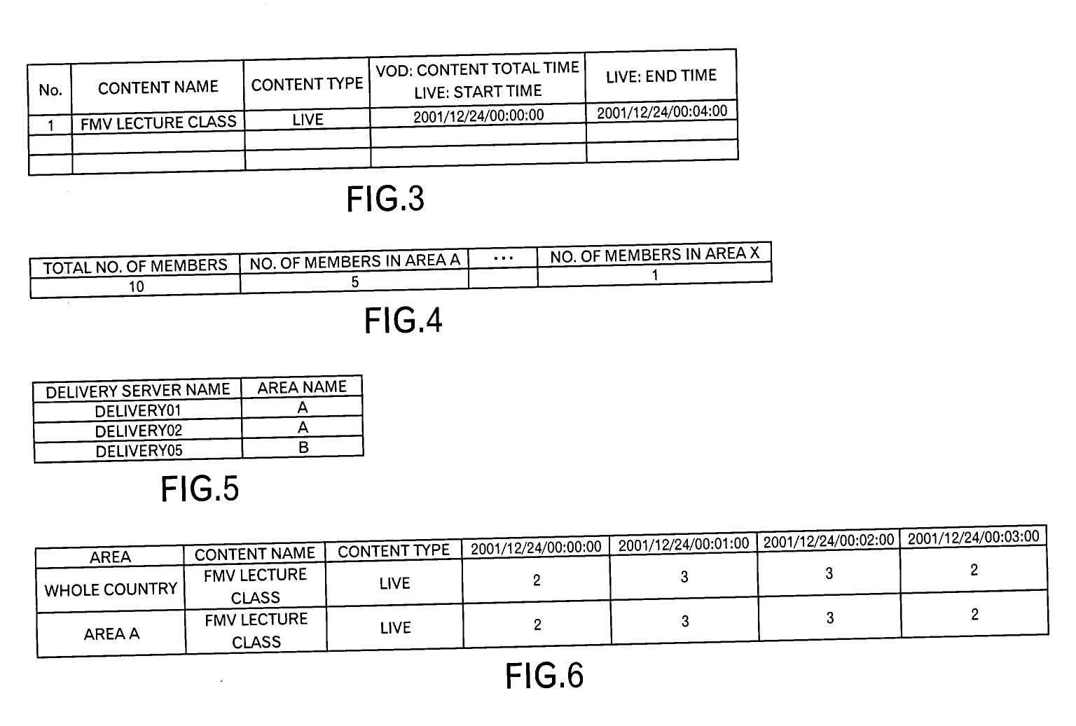

Next, a processing in the audience rating calculation system 53 shown in FIG. 1 will be described with reference to FIGS. 2 to 20. First, a preprocessing of audience rating calculation will be described with reference to FIG. 2. The audience rating calculation system 53 stores a content name (or content ID), a content type, a content total time in the case of VOD delivery content, and a start time and an end time in the case of Live delivery content into the content information DB 532 (step S1). An example of data stored in the content information DB 532 is shown in FIG. 3. In the example of FIG. 3, there are stored a content name (FMV lecture class), a content type (Live), a content total time of VOD delivery content or a start time of Live delivery content (2001/12/24 00:00:00 since it is Live), and an end time of Live delivery (2001/12/24 00:04:00 since it is Live)

Besides, the total number of members and the number of members in each area are stored in the member information DB 533 (step S3). An example of data stored in the member information DB 533 is shown in FIG. 4. In the example of FIG. 4, there are stored the total number (10) of members, the number (5) of members of an area A, . . . , the number (1) of members of an area X.

A delivery server name belonging to each area is stored in the location information DB 536 (step S5). An example of data stored in the location information DB 536 is shown in FIG. 5. In the example of FIG. 5, there are stored delivery server names (delivery 01, delivery 02, delivery 05), and area names (A, A, B).

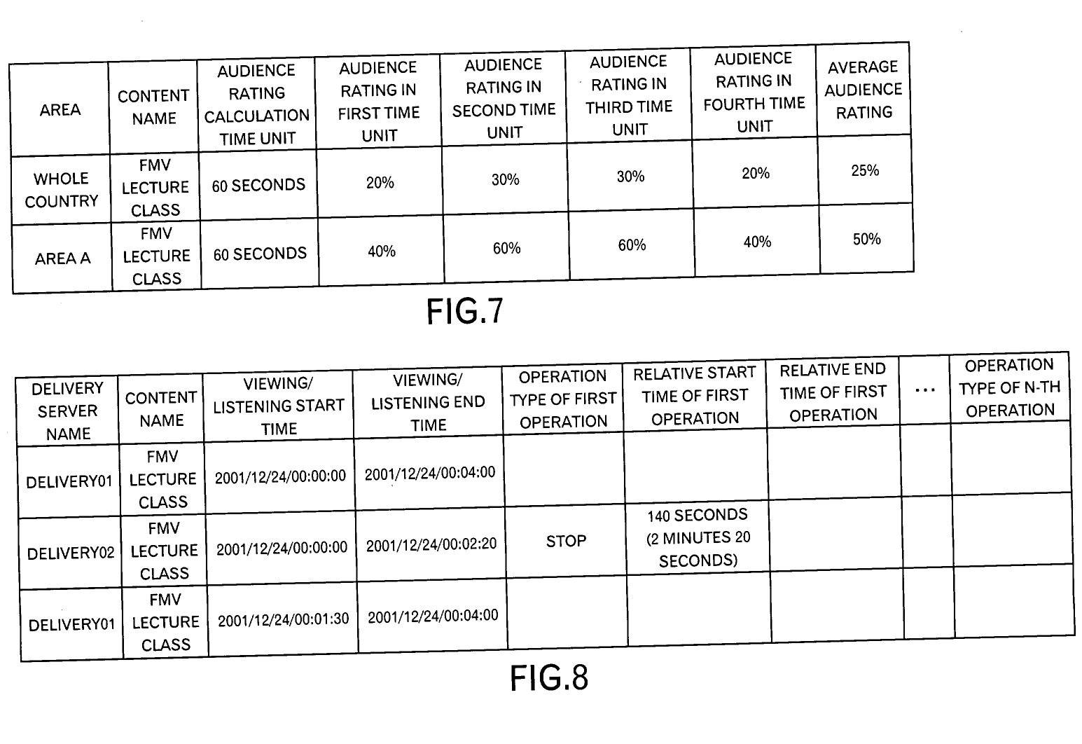

A time unit for count of an audience number is stored in the audience rating information DB 535 (step S7). Here, the length of the time unit is stored. For example, it is 60 seconds. However, the time unit need not be uniform for all contents, and it can be varied also in the content. In this embodiment, for simplification of the explanation, it is assumed that there is only one kind of 60 seconds. Incidentally, by using information of the length of the time unit stored in the audience rating information DB 535, tables as shown in FIGS. 6 and 7 are generated in a later processing. FIG. 6 shows an audience number table used for count of the audience number, and there are stored an area (whole country, area A), a content name (FMV lecture class), a content type (Live), an audience number (2, 2) in a first time unit (whose start time is 2001/12/24/00:00:00), an audience number (3, 3) in a second time unit (whose start time is 2001/12/24/00:01:00), an audience number (3, 3) in a third time unit (whose start time is 2001/12/24/00:02:00), and an audience number (2, 2) in a fourth time unit (whose start time is 2001/12/24/00:03:00). Although there are only four time units since it is a four-minute content, the number of time units is different in accordance with the length of the time unit and the length of the content.

FIG. 7 is an audience rating table for storing information of an audience rating calculated using the audience number shown in FIG. 6, and there are stored an area (whole country, area A), a content name (FMV lecture class), an audience rating calculation time unit (60 seconds), an audience rating (20%, 40%) in the first time unit, an audience rating (30%, 60%) in the second time unit, an audience rating (30%, 60%) in the third time unit, an audience rating (30%, 60%) in the fourth time unit, and an average audience rating (25%, 50%).

Incidentally, an example of data stored in the delivery log information DB 531 is shown in FIG. 8. In the example of FIG. 8, there are stored a delivery server name (delivery 01, delivery 02, delivery 01), a content name (FMV lecture class), a viewing/listening start time (2001/12/24/00:00:00, 2001/12/24/00:00:00, 2001/12/24/00:01:30), a viewing/listening end time (2001/12/24/00:04:00, 2001/12/24/00:02:20, 2001/12/24/00:04:00), a type of a first operation (blank, stop, blank), a relative start time of the first operation (blank, 140 seconds (2 minutes and 20 seconds), blank), a relative end time of the first operation (blank, blank, blank), . . . , an operation type of the n-th operation, . . .

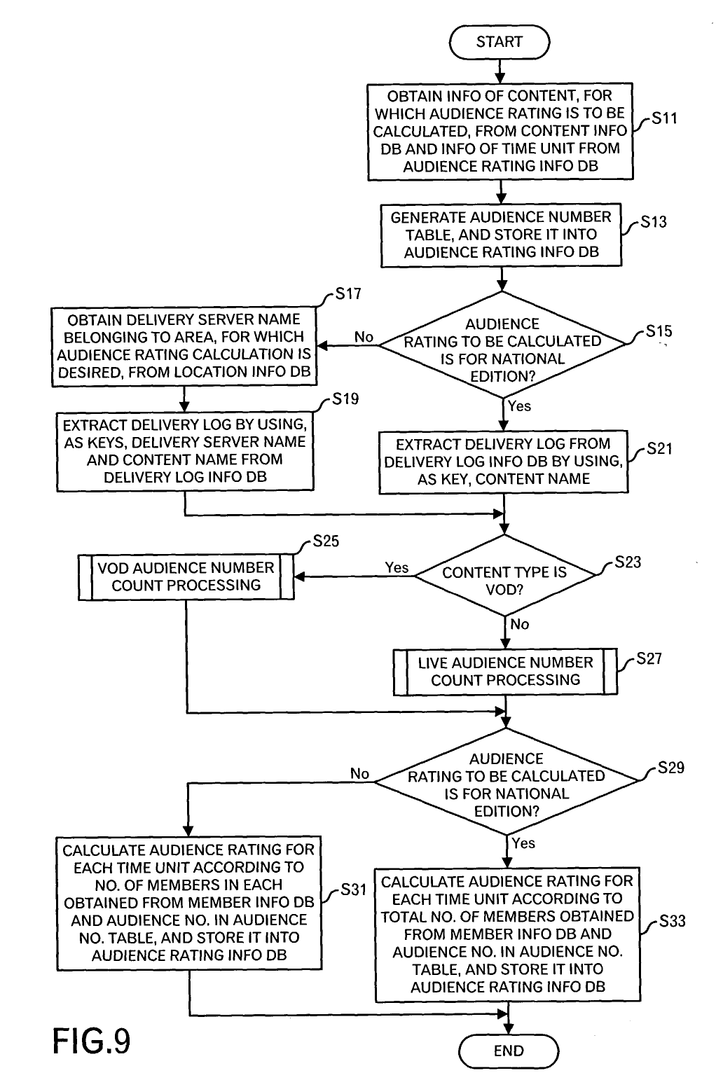

Next, an audience rating calculation processing will be described with reference to FIG. 9. The audience rating calculator 534 of the audience rating calculation system 53 uses the content name or the content ID to acquire the information (content type, content total time in the case of VOD or a delivery start time and a delivery end time in the case of Live delivery content) of the content for which the audience rating is to be calculated from the content information DB 532, and the information of the time unit from the audience rating information DB 535 (step S11). Besides, the audience number table (FIG. 6) is generated and is stored in the audience rating information DB 535 (step S13)—that is, the audience rating calculator 534 provides a column of an area, a column of a content name or a content ID, a column of a content type, and a column of a time unit, and stores information of the content name or content ID and the content type.

Next, it is judged whether an audience rating to be calculated is for a national edition or a local edition (step S15). If it is for the local edition, the delivery server name belonging to the area in which the audience rating is desired to be obtained is acquired from the location information DB 536 (step S17)—then, the information of the delivery log is extracted from the delivery log information DB 531 by using the delivery server name and the content name as keys (step S19). For example, in the case where the area name A is an audience rating calculation area, referring to FIG. 5, the delivery log is extracted in regard to the delivery servers of the delivery 01 and the delivery 02. Accordingly, delivery log for which delivery 01 and delivery 02 are stored in the column of the delivery server name of the delivery log information DB 531 shown in FIG. 8 is extracted. FIG. 8 shows a state where it has been already extracted (since there is only one content).

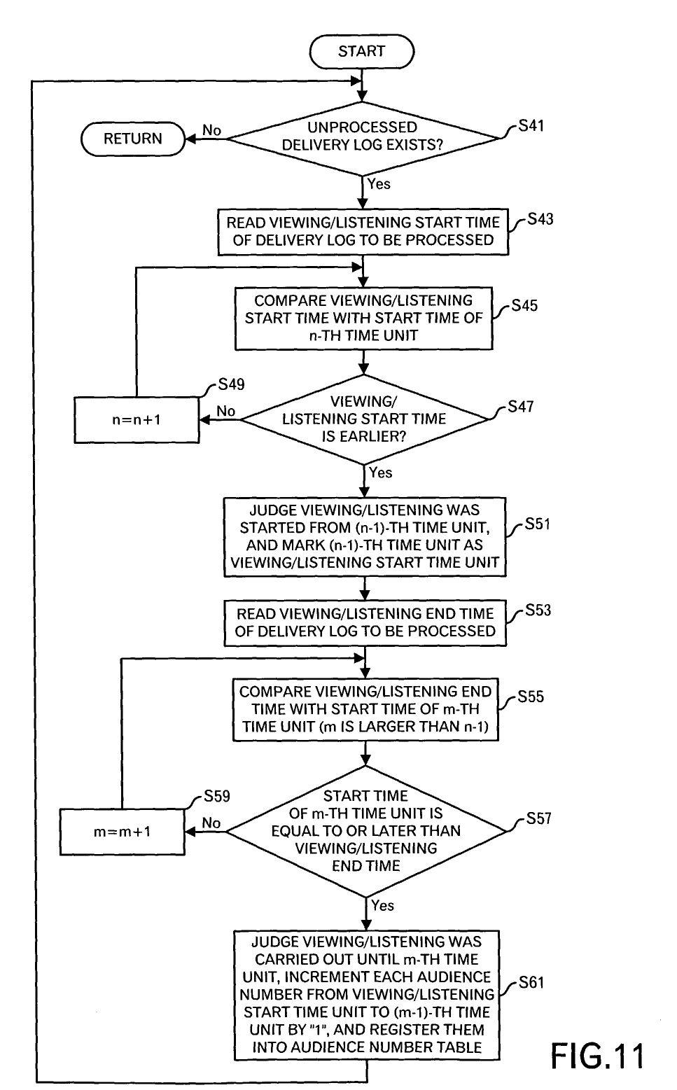

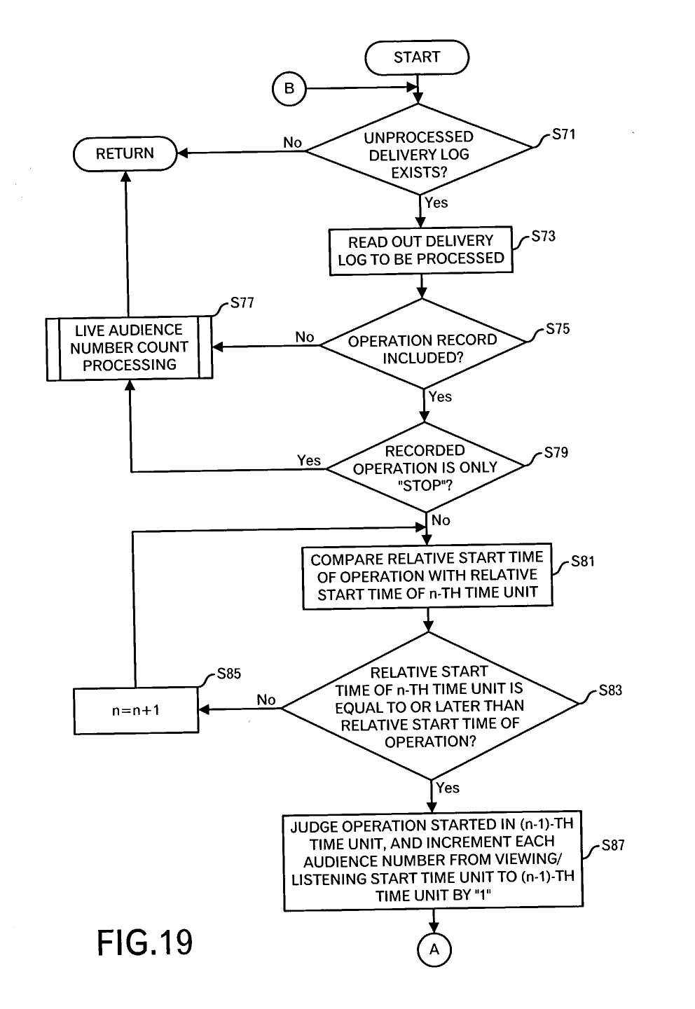

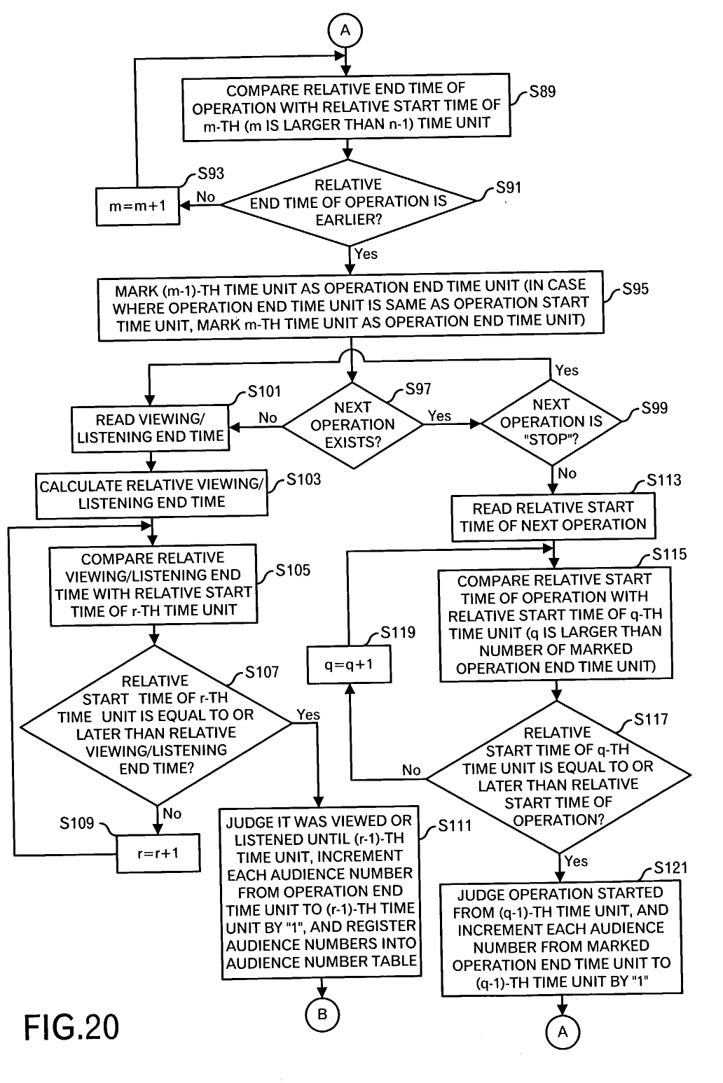

On the other hand, in the case where the audience rating of the national edition is to be calculated, all delivery log generated whenever the content was viewed or listened is extracted from the delivery log information DB 531 by using, as a key, the name (or ID) of the content the audience rating of which is to be calculated (step S21). For example, in the case where the name of the content the audience rating of which is to be calculated is the FMV lecture class, the delivery log becomes as shown in FIG. 8. Then, reference is made to the information of the content type acquired at the step S11 and stored in the audience number table, and it is judged whether the type of the content the audience rating of which is to be calculated is Live or VOD (step S23). If the content type is VOD, a VOD audience number count processing (FIGS. 19 and 20) is carried out (step S25) On the other hand, if the content type is Live, a live audience number count processing (FIG. 11) is carried out (step S27).

Then, it is judged whether the audience rating to be calculated again is for the national edition or the local edition (step S29). In the case of the local edition, the number of members of the area in which the audience rating is to be calculated is acquired from the member information DB 533, the information of the audience number is acquired from the audience number table (FIG. 6), and the audience rating is calculated in every time unit from the number of members of the area and the audience number. In addition, the average audience rating is also calculated. Then, the calculation result is stored as the audience rating table (FIG. 7) into the audience rating information DB 535 (step S31)—that is, there are provided a column of area, a column of content name, a column of the length of the audience rating calculation time unit, a column of an audience rating in the first time unit, a column of an audience rating in the second time unit, . . . , a column of an audience rating in the n-th time unit, and a column of an average audience rating, and there are stored an area name for which the audience rating is calculated, a content name, the length of a time unit, the audience rating calculated in each time unit, and the average audience rating.

On the other hand, in the case where the audience rating to be calculated is for the national edition, the total number of members is acquired from the member information DB 533, the information of the audience number is acquired from the audience number table (FIG. 6), and the audience rating is calculated in every time unit from the total number of members and the audience number. In addition, the average audience rating is also calculated. Then, the calculation result is stored as the audience rating table (FIG. 7) in the audience rating information DB 535 (step S33)—that is, there are provided a column of area, a column of content name, a column of the length of the time unit for calculating the audience rating, a column of an audience rating in the first time unit, a column of an audience rating in the second time unit, . . . , a column of an audience rating in the n-th time unit, and a column of an average audience rating, and there are stored the whole country as area information, a content name, the length of a time unit, the audience rating calculated in each time unit, and the average audience rating.

In this embodiment, the audience rating is calculated in accordance with the following expressions:

audience rating in every time unit=(total audience number in every time unit)/(total number of members (national edition) or number of members of a local area (local edition)×100;

average audience rating=(total audience number in all time units)/((total number of members (national edition) or number of members of a local area (local edition)×number of time units)×100.

By doing so, the audience number and the audience rating in each time unit, and the average audience rating can be calculated, and the sponsor can judge the cost effectiveness of the advertisement and the propriety of the provision of the advertisement. Besides, since the audience number and the audience rating and the average audience rating in every area can be calculated, the sponsor can also make a judgment for every area. Further, since the audience number and the audience rating in a time unit can be calculated, the time change and the peak of the audience number and the audience rating can be specified. That is, it becomes possible to consider which part of a single content fascinates audiences.

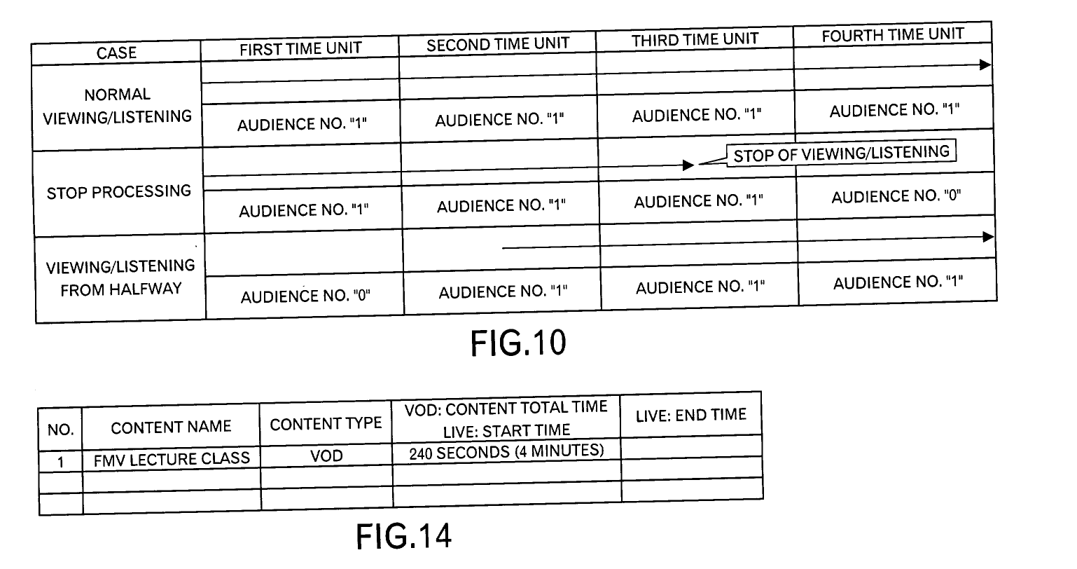

Next, an audience number count processing in the case of Live delivery content will be described with reference to FIGS. 10 and 11. Before a specific processing flow is described, a policy of audience number count will be described with reference to FIG. 10. In FIG. 10, typical three cases are described. The first case shows a normal viewing/listening pattern and shows a case in which viewing/listening is carried out in the whole from the beginning of the first time unit to the last of the fourth time unit (final time unit)-that is, the audience number in each of the first time unit to the fourth time unit is counted as “1”. The second case shows a pattern in which viewing/listening is stopped halfway, and shows a case in which viewing/listening is carried out from the beginning of the first time unit to a halfway point of the third time unit. In this case, since the whole in the time unit is viewed or listened with respect to the first and the second time units, the audience number in each of the first and the second time units is counted as “1”. In this embodiment, even in the case where viewing/listening is stopped halfway, the whole is regarded as having been viewed or listened and the audience number of the third time unit is also counted as “1”. The third case indicates a pattern in which viewing/listening is started from a halfway point, and indicates a case in which viewing/listening is carried out from a halfway point of the second time unit to the last of the fourth time unit. In this case, since the whole in the time unit is viewed with respect to the third and the fourth time units, the audience number of each of the third and the fourth time units is counted as “1”. In this embodiment, even in the case where viewing/listening is started from a halfway point, the whole is regarded as having been viewed or listened and the audience number of the second time unit is also counted as “1”. As described above, even when viewing/listening is started from or stopped at a halfway point of a time unit, the audience number is counted as “1”.

In the data of the delivery log information DB 531 shown in FIG. 8, the three patterns of FIG. 10 are recorded. With respect to the first record concerning the delivery of the delivery server 01, the first case is shown, the viewing/listening start time is the delivery start time, the viewing/listening end time is the delivery end time, and any operation is not performed halfway. With respect to the second record concerning the delivery of the delivery server 02, the second case is shown, and although the viewing/listening start time is the delivery start time, the viewing/listening end time is after 2 minutes and 20 seconds, and if the time unit is 60 seconds, it is recorded that viewing/listening is stopped at a halfway point of the third time unit. This is recorded as “stop” also as the first operation, and 140 seconds (2 minutes and 20 seconds) is also recorded as the relative operation start time. With respect to the third record concerning the delivery of the delivery server 01, the third case is shown, the viewing/listening start time is after 1 minute and 30 seconds from the delivery start time, the viewing/listening end time is the delivery end time, and any operation is not performed halfway.

As stated above, in the case where the delivery log as shown in FIG. 8 is recorded, the time change of the audience number as shown in FIG. 6 is recorded. That is, in the first time unit, the audience number is counted as “2” according to the first record and the second record of FIG. 8. Besides, with respect to the second time unit, since it is judged that viewing/listening is started in the third record, the audience number is counted as “3” according to the first record, the second record, and the third record of FIG. 8. Further, with respect to the third time unit, although it is judged that viewing/listening is stopped in the second record, the audience number is counted as “3” according to the first record, the second record, and the third record of FIG. 8. Further, with respect to the fourth time unit, the audience number is counted as “2” according to the first record and the third record.

Since the total number of members is 10 from FIG. 4, the audience rating of the national edition in each time unit and the average audience rating become those in the first line of the audience rating table of FIG. 7. That is, the audience rating is calculated as follows: 2 (persons)/10 (persons)×100=20% with respect to the first time unit; 3 (persons)/10 (persons)×100=30% with respect to the second time unit; 3 (persons)/10 (persons)×100=30% with respect to the third time unit, and 2 (persons)/10 (persons)×100=20% with respect to the fourth time unit. The average audience rating becomes (2+3+3+2) (total audience number)/(10×4) (total number of members×number of time units)×100=25%.

Since the number of members of the area A is 5 from FIG. 4, the audience rating of the area A in each time unit and the average audience rating becomes those in the second line of the audience rating table of FIG. 7. That is, the audience rating is calculated as follows: ⅖×100=40% with respect to the first time unit; ⅗×100=60% with respect to the second time unit; ⅗×100=60% with respect to the third time unit; and ⅖×100=40% with respect to the fourth time unit. The average audience rating becomes (2+3+3+2) (total audience number)/(5×4) (number of members of the area A×number of time units)×100=50%.

FIG. 11 shows a processing for carrying out the count of the audience number as shown in FIG. 6. This processing is carried out by the live audience number count processor 539. The Live audience number count processor 539 judges whether an unprocessed delivery log remains in the delivery log extracted at the step S21 or step S19 (step S41). If the unprocessed delivery log is not remained, the processing is ended (step S41: No route). In the case where the unprocessed delivery log remains (step S41: Yes route)—the viewing/listening start time of the delivery log to be processed is read (step S43)—then, the viewing/listening start time is compared with the start time of an n-th time unit (n is an integer and is started from n=1) (step S45)—then, it is judged whether the viewing/listening start time is earlier than the start time of the n-th time unit (step S47). In case where the viewing/listening start time is not earlier (including the case of the same) (step S47: No route), n is incremented by one (step S49)—then, the procedure returns to the step S45.

On the other hand, in the case where it is judged that the viewing/listening start time is earlier than the start time of the n-th time unit (step S47: Yes route), it is determined that viewing/listening is started from the (n−1)-th time unit, and the (n−1)-th time unit is marked as the viewing/listening start time unit (step S51)—that is, the (n−1)-th time unit is recorded in the storage device. In the case where the viewing/listening start time is equal to the start time of the n-th time unit, or in the case where the viewing/listening start time is in the n-th time unit, viewing/listening is regarded as having started from the beginning of the n-th time unit. Thus, the viewing/listening start time is compared with the start time of the (n+1)-th time unit, and until it is judged that the viewing/listening start time is earlier, the processing is performed so that the step S47 proceeds to the step S49.

Next, the viewing/listening end time of the delivery log to be processed is read (step S53)—then, the viewing/listening end time is compared with the start time of the m-th (m is an integer and starts here from m=n−1) time unit (step S55)—then, in the case where the start time of the m-th time unit is earlier than the viewing/listening end time (step S57: No route), m is incremented by one, and the procedure is returned to the step S55 (step S59). On the other hand, in the case where the start time of the m-th time unit is equal to or later than the viewing/listening end time, it is determined that viewing/listening is carried out until the (m−1)-th time unit, the audience number from the viewing/listening start time unit to the (m−1)-th time unit is increased by one, and is registered in the audience number table (step S61). In the case where the start time of the (m+1)-th time unit is equal to the viewing/listening end time, or in the case where the start time of the (m+1)-th time unit is later than the viewing/listening end time, viewing/listening is ended in the m-th time unit. Thus, until the start time of the (m+1)-th time unit is compared with the viewing/listening end time, the step S57 proceeds to the step S59. Incidentally, even in the case where there are only p time units, the processing is carried out until a comparison with the start time of the (p+1)-th time unit (end time of the p-th time unit) is carried out.

By carrying out the processing as stated above, the policy of the audience number count as shown in FIG. 10 can be embodied.

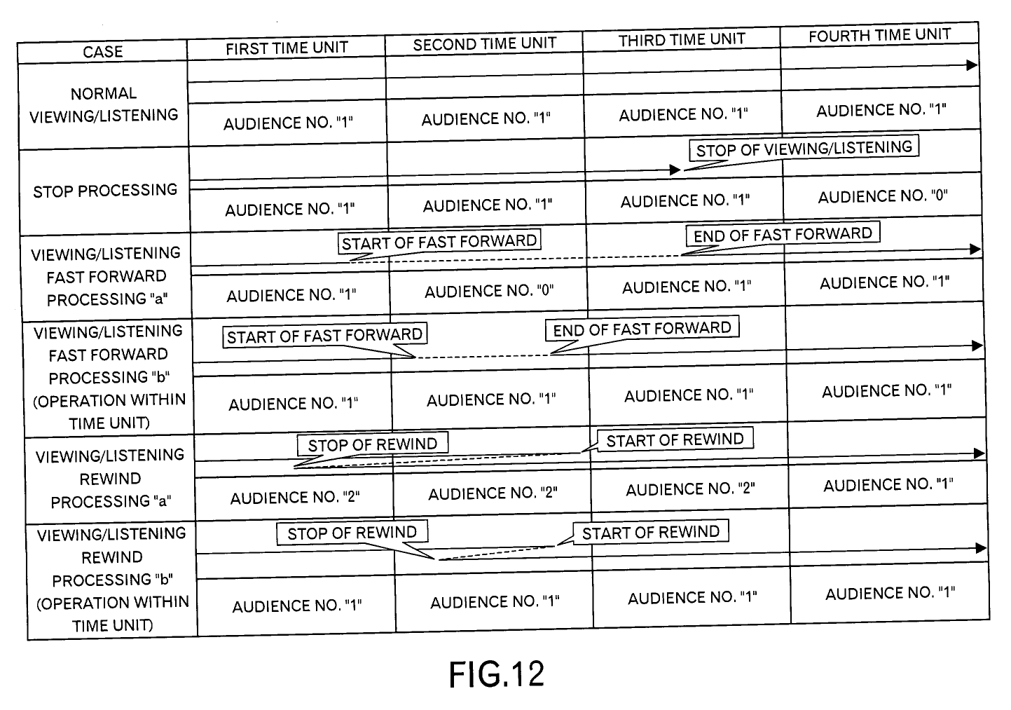

Next, an audience number count processing in the case of VOD delivery content will be described with reference to FIGS. 12 to 20. Before a specific processing flow is described, a policy of audience number count will be described with reference to FIG. 12. In FIG. 12, six typical cases are described. The first case indicates a normal viewing/listening pattern and is a case in which viewing/listening is carried out in the whole from a relative start time of the first time unit to a relative end time of the fourth time unit (last time unit). In this case, the audience number is counted as “1” from the first time unit to the fourth time unit. The second case indicates a pattern in which viewing/listening is stopped halfway, and is a case in which viewing/listening is started from the relative start time of the first time unit and viewing/listening is stopped at a halfway point in the third time unit. In this case, since the whole of the time unit is viewed or listened with respect to the first and the second time units, the audience number of each of the first and the second time units is counted as “1”. In this embodiment, even in the case where viewing/listening is stopped at a halfway point, the whole is regarded as having been viewed or listened, and the audience number of the third time unit is also counted as “1”. The third case indicates a case (viewing/listening fast forward processing “a”) in which a audience gives an instruction of fast forward exceeding a time unit in the middle of viewing/listening, and is a case in which after viewing/listening is carried out from the relative start time of the first time unit to a halfway point of the first time unit, fast forward is made to a halfway point of the third time unit, and viewing/listening is carried out from the halfway point of the third time unit to the relative end time of the fourth time unit. In the case of this example, although the whole of the first time unit is not viewed or listened, in this embodiment, the whole is regarded as having been viewed or listened, and the audience number of the first time unit is counted as “1”. However, with respect to the second time unit, since no viewing/listening is carried out, the count of the audience number is not carried out. Also with respect to the third time unit, since viewing/listening is started from a halfway point, the whole is not viewed or listened, however, in this embodiment, the whole is regarded as having been viewed or listened, and the audience number of the third time unit is counted as “1”. With respect to the fourth time unit, since the whole is viewed, the audience number is counted as “1”.

The fourth case indicates a case (viewing/listening fast forward processing “b” (operation within a time unit)) in which a audience gives an instruction of fast forward within a time unit in the middle of viewing/listening, and is a case in which viewing/listening is carried out from the relative start time of the first time unit to a halfway point of the second time unit, and then, fast forward is carried out to another time in the second time unit, and viewing/listening is carried out from the halfway time of the second time unit to the relative end time of the fourth time unit. With respect to the first time unit, since the whole is viewed or listened, the audience number is counted as “1”. With respect to the second time unit, although there is an interval in which viewing/listening is not made halfway, in this embodiment, the whole is regarded as having been viewed or listened, and the audience number is counted as “1”. With respect to the third and the fourth time units, since the whole is viewed or listened, the audience number is counted as “1”.

The fifth case indicates a case (viewing/listening rewind processing “a”) in which a audience gives an instruction of rewind, and is a case in which after viewing/listening is once made from the relative start time of the first time unit to a halfway point of the third time unit, rewind is carried out to a halfway point of the first time unit, and viewing/listening is carried out from the halfway point of the first time unit to the relative end time of the fourth time unit. In the case of this example, the audience number is counted as to the viewing/listening from the relative start time of the first time unit to the halfway point of the third time unit, and the viewing/listening from the halfway point of the first time unit to the relative end time of the fourth time unit. That is, with respect to the first time unit, since viewing/listening is carried out once in the whole, and viewing/listening is carried out once from the halfway point to the last, the audience number is counted as “2”. With respect to the second time unit, viewing/listening is carried out twice in the whole, the audience number is counted as “2”. With respect to the third time unit, since viewing/listening is carried out once to the halfway point, and viewing/listening is carried out once in the whole, the audience number is counted as “2”. With respect to the fourth time unit, since viewing/listening is carried out only once, the audience number is counted as “1”.

The sixth case indicates a case (viewing/listening rewind processing “b” (operation within a time unit)) in which a audience gives an instruction of rewind within a time unit, and is a case in which after viewing/listening is carried out once from the relative start time of the first time unit to a halfway point of the second time unit, rewind is carried out to a certain relative time of the second time unit, and viewing/listening is carried out from the certain relative time of the second time unit to the relative end time of the fourth time unit. In this example, in the second time unit, there is an interval in which viewing/listening is carried out repeatedly, however, in this embodiment, such repetition in the time unit is not considered. That is, the audience number of the second time unit is counted as “1”. Since viewing/listening is carried out only once as to the other time units, the audience number of each of all other time units is counted as “1”.

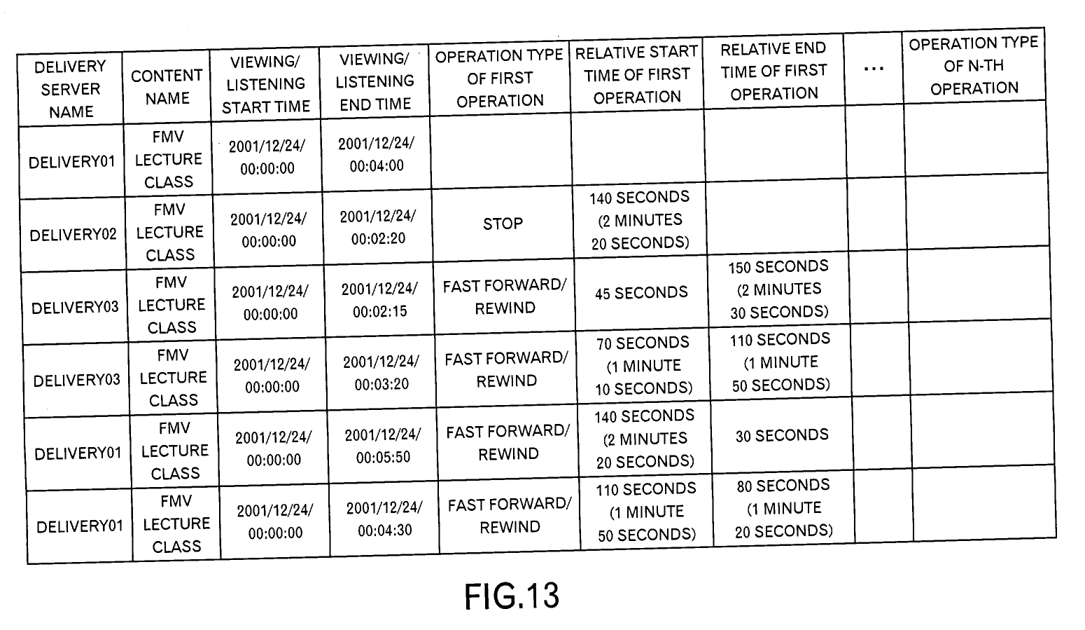

The delivery log as to the first to sixth cases in FIG. 12 is stored in the delivery log information DB 531 as shown in FIG. 13. Incidentally, for convenience of explanation, it is assumed that all audiences start to view or listen at 2001/12/24/00:00:00. The first record relating to the delivery by the delivery server of the delivery 01 corresponds to the first case in FIG. 12. In the first record, it is recorded that the viewing/listening start time is 2001/12/24/00:00:00, the viewing/listening end time is 2001/12/24/00:04:00, any operation is not performed, and viewing/listening is carried out from the beginning to the last. The second record relating to the delivery by the delivery server of the delivery 02 corresponds to the second case of FIG. 12. In the second record, it is recorded that the viewing/listening start time is 2001/12/24/00:00:00, the viewing/listening end time is 2001/12/24/00:02:20, “stop” is performed as the first operation, and it is also recorded that the relative start time of the first operation is 140 seconds (2 minutes and 20 seconds). That is, it is indicated that viewing/listening is stopped after 2 minutes and 20 seconds.

The third record relating to the delivery by the delivery server of the delivery 03 corresponds to the third case in FIG. 12. In the third record, it is recorded that the viewing/listening start time is 2001/12/24/00:00:00, the viewing/listening end time is 2001/12/24/00:02:15, and “fast forward/rewind” is performed as the first operation, and it is also recorded that the relative start time of the first operation is 45 seconds, and the relative end time of the first operation is 150 seconds (2 minutes and 30 seconds). In this embodiment, although the delivery server can recognize only that the kind of the operation is either “fast forward” or “rewind”, it is possible to judge whether the kind is “fast forward” or “rewind” from the relation between the relative start time and the relative end time. In the third record, since the relative end time is later than the relative start time, it is understood that the fast forward is carried out.

The fourth record relating to the delivery by the delivery server of the delivery 03 corresponds to the fourth case in FIG. 12. In the fourth record, it is recorded that the viewing/listening start time is 2001/12/24/00:00:00, the viewing/listening end time is 2000/12/24/00:03:20, and “fast forward/rewind” was carried out as the first operation, and it is also recorded that the relative start time of the first operation is 70 seconds (1 minute and 10 seconds), and the relative end time of the first operation is 110 second (1 minute and 50 seconds). Since the relative end time of the first operation is later than the relative start time, it is understood that the operation is the fast forward.

The fifth record relating to the delivery by the delivery server of the delivery 01 corresponds to the fifth case in FIG. 12. In the fifth record, it is recorded that the viewing/listening start time is 2001/12/24/00:00:00, the viewing/listening end time is 2001/12/24/00;05:50, and “fast forward/rewind” was carried out as the first operation, and it is also recorded that the relative start time of the first operation is 140 seconds (2 minutes and 20 seconds), and the relative end time of the first operation is 30 seconds. Since the relative start time of the first operation is later than the relative end time, it is understood that the operation is the rewind.

The sixth record relating to the delivery by the delivery server of the delivery 01 corresponds to the sixth case in FIG. 12. In the sixth record, it is recorded that the viewing/listening start time is 2001/12/24/00:00:00, the viewing/listening end time is 2001/12/24/00:04:30, and “fast forward/rewind” was carried out as the first operation, and it is also recorded that the relative start time of the first operation is 110 seconds (1 minute and 50 seconds), and the relative end time of the first operation is 80 seconds (1 minute and 20 seconds). Since the relative start time of the first operation is later than the relative end time, it is understood that the operation is the rewind.

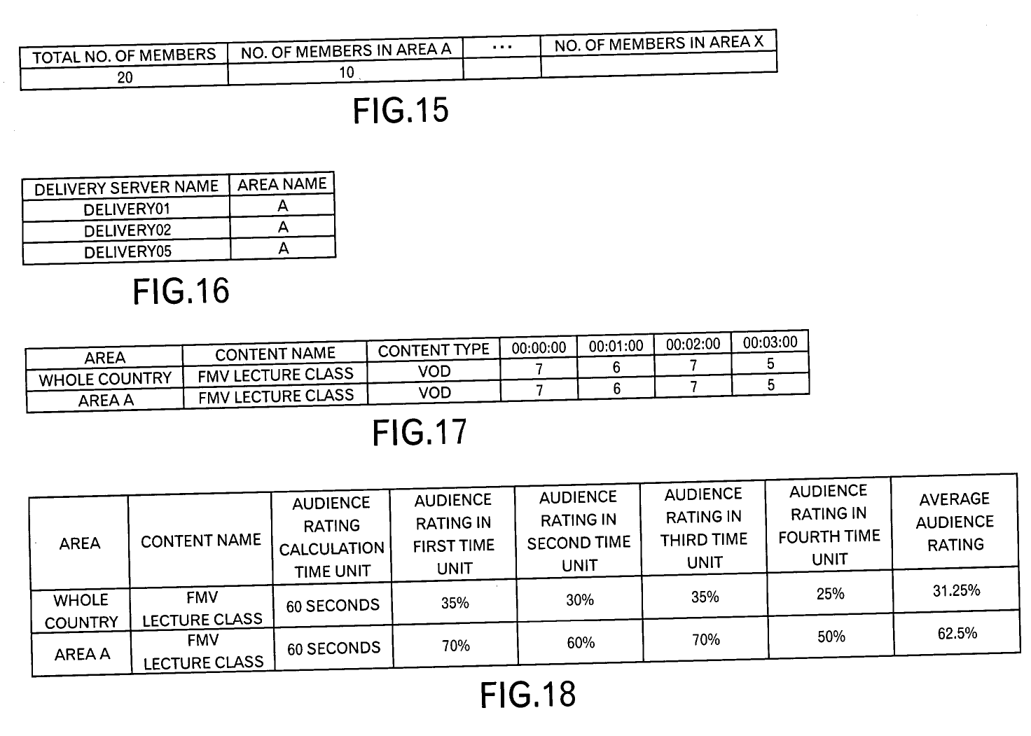

FIG. 14 shows an example of data stored in the content information DB 532 when the delivery log shown in FIG. 13 is processed. In the example of FIG. 14, there are stored a content name or a content ID (FMV lecture class), a content type (VOD), and a content total time (240 seconds: 4 minutes) in the case of VOD. FIG. 15 shows an example of data stored in the member information DB 533 when the delivery log shown in FIG. 13 is processed. In the example of FIG. 15, there are stored the total number (20) of members, the number (10) of members of an area A, . . . , and the number of members of an area X. FIG. 16 shows an example of data stored in the location information DB 536 when the delivery log shown in FIG. 13 is processed. In the example of FIG. 16, there are stored a delivery server name (delivery 01, delivery 02, delivery 03), and an area name (A).

According to the information stored in the delivery log information DB 531, the content information DB 532, the location information DB 536, and the member information DB 533 shown in FIGS. 13 to 16, the audience number table included in the audience rating information DB 535 becomes as shown in FIG. 17. Incidentally, since it is understood from FIGS. 13 to 16 that there is no delivery other than the delivery to the area A, the whole contrary and the area A becomes equal in audience number. Besides, it is understood that the content name is FMV lecture class from FIG. 13, and the content type is VOD from FIG. 14, and the information of those is stored in the audience number table. The relative start time of the first time unit is 00:00:00, the audience number of the first time unit becomes 7 when all the audience numbers in the first time unit, which are shown in FIG. 12, are added, and the information of those is stored in the audience number table. The relative start time of the second time unit is 00:01:00, the audience number of the second time unit becomes 6 when all the audience numbers in the second time unit, which are shown in FIG. 12, are added, and the information of those is stored in the audience number table. The relative start time of the third time unit is 00:02:00, the audience number of the third time unit becomes 7 when all the audience numbers in the third time unit, which are shown in FIG. 12, are added, and the information of those is stored in the audience number table. The relative start time of the second time unit is 00:03:00, the audience number of the fourth time unit becomes 5 when all the audience numbers in the fourth time unit of FIG. 12 are added, and the information of those is stored in the audience number table.

When the audience number table as shown in FIG. 17 is generated, the audience rating table as shown in FIG. 18 can be generated on the basis of the foregoing calculation expressions of the audience rating in each time unit and the average audience rating. In the example of FIG. 18, there are provided a column of area (whole country, area A), a column of content name (FMV lecture class), a column of the audience rating calculation time unit (60 seconds), and a column of an audience rating in each time unit. The audience rating of the whole country in the first time unit is 7 (persons)/20 (persons)×100=35%, and the audience rating of the area A is 7 (persons)/10 (persons)×100=70%. Besides, the audience rating of the whole country in the second time unit is 6 (persons)/20 (persons)×100=30%, and the audience rating of the area A is 6 (persons)/10 (persons)×100=60%. The audience rating of the whole country in the third time unit is 7 (persons)/20 (persons)×100=35%, and the audience rating of the area A is 7 (persons)/10 (persons)×100=70%. The audience rating of the whole country in the fourth time unit is 5 (persons)/20 (persons)×100=25%, and the audience rating of the area A is 5 (persons)/10 (persons)×100=50%. The average audience rating of the whole country is (7+6+7+5)/(20×4)×100=31.25%, and the average audience rating of the area A is (7+6+7+5)/(20×4)×100=62.5%.

FIGS. 19 and 20 show a processing flow for generating the audience number table as shown in FIG. 17. This processing is carried out by the VOD audience number count processor 537. The VOD audience number count processor 537 judges whether an unprocessed delivery log remains in the delivery log extracted at the step S21 or step S19 (step S71). If the unprocessed delivery log does not remain, the processing is ended (step S71: No route). In the case where the unprocessed delivery log remains (step S71: Yes route), the information of the delivery log to be processed is read out (step S73). Then, it is judged whether an operation record is included in the information of the read delivery log (step S75). For example, it is judged whether fast forward/rewind or stop is recorded. In case the operation record is not included (step S75: No route), since it is equivalent to the case of Live, the live audience number count processing (FIG. 11) is carried out (step S77). On the other hand, in the case where some operation records are included (step S75: Yes route), it is confirmed whether the operation record indicates only the stop (step S79). In case the operation record indicates only the stop (step S79: Yes route), the procedure proceeds to step S77 and a live audience number count processing is carried out. In the case where the live audience number count processing is carried out, the processing proceeds to the original processing shown in FIG. 9.

On the other hand, in the case where not only the stop but also the fast forward/rewind is recorded as the operation carried out (step S79: No route), the relative start time of the first operation is compared with the relative start time of the n-th (n is an integer and starts from n=1) time unit (step S81). In case the relative start time of the n-th time unit is earlier than the relative start time of the operation (step S83: No step), n is incremented by one (step S85). Then, the processing returns to the step S81. In case the relative start time of the n-th time unit is equal to or later than the relative start time of the operation, it is judged that the operation is started in the (n−1)-th time unit, and the audience number from the viewing/listening start time unit to the (n-l)-th time unit is increased by one (step S87). The viewing/listening start time unit is the first time unit in the case of the first operation. In the case where the relative start time of the (n+1)-th time unit is equal to the relative start time of the operation, or in the case where the relative start time of the (n+1)-th time unit is later than the relative start time of the operation, since the operation is started in the n-th time unit, the step S83 proceeds to the step S85 until the relative start time of the (n+1)-th time unit is compared with the relative start time of the operation. Incidentally, even in the case where only s time units exist, the processing is carried out until a comparison with the start time of the (s+1)-th time unit (end time of the s-th time unit) is carried out. After the step S87, the processing proceeds to the processing of FIG. 20 through terminal A.

In FIG. 20, first, the relative end time of the operation is compared with the relative start time of the m-th (m is an integer and starts from (n−1)) time unit. It is judged whether the relative end time of the operation is earlier than the start time of the m-th time unit (step S91). In the case where the relative end time of the operation is not earlier (including the case of the same) (step S91: No route), m is incremented by one (step S93). Then, the processing returns to the step S89. On the other hand, in the case where the relative end time of the operation is earlier than the start time of the m-th time unit, the (m−1)-th time unit is marked as the operation end time unit (step S95). That is, (m−1)-th time unit is stored in the storage device. However, in the case where the end time unit of the operation is equal to the start time unit of the operation judged at the step S89, in accordance with the policy (the fourth and sixth cases of FIG. 12) of this embodiment in which the count of the audience number is not performed for the operation in the same time unit, the m-th time unit is marked as the end time unit of the operation.

Then, it is judged whether a next operation is recorded in the delivery log (step S97). If there is no next operation (step S97: No route), the viewing/listening end time as to the delivery log is read (step S101). On the other hand, in the case where it is judged at the step S97 that there is a next operation, it is judged whether or not the next operation is the stop (step S99). In case the next operation is stop, the processing proceeds to the step S101.

After the step S101, the relative viewing/listening end time is obtained from the read viewing/listening end time (step S103). If the last operation is stop, since the relative start time is recorded, the relative viewing/listening end time is the relative start time for the stop operation. If the final operation is not “stop”, the relative end time is subtracted from the relative start time of each operation, and the results are added, so that an overlapping time (, which may be negative) is calculated. Then, the VOD content total time is read out from the content information DB 532, and the VOD content total time and the overlapping time are added to calculate the first viewing/listening time. On the other hand, the viewing/listening start time is subtracted from the viewing/listening end time to calculate the second viewing/listening time. If the first viewing/listening time and the second viewing/listening time are equal to each other, it is understood that the case was not such that an abnormal end occurred because a line was disconnected halfway, or an audience terminal was hung up. That is, viewing/listening was carried out to the last, and the relative viewing/listening end time becomes equal to the VOD content total time. On the other hand, in the case where the first viewing/listening time is longer than the second viewing/listening time, it is understood that the delivery was abnormally ended halfway. Accordingly, the second viewing/listening time is subtracted from the first viewing/listening time, and the time obtained by subtracting the difference between the first viewing/listening time and the second viewing/listening time from the VOD content total time becomes a relative viewing/listening end time. Incidentally, in this embodiment, the first viewing/listening time can not be shorter than the second viewing/listening time. Even if the delivery was abnormally ended, in the case where the operation of stop is recorded, the relative start time of the stop operation becomes the relative viewing/listening end time.

Then, the relative viewing/listening end time is compared with the relative start time of the r-th time unit (step S105). In case the relative start time of the r-th time unit is earlier than the relative viewing/listening end time (step S107: No route), r is incremented by one, and the processing returns to the step S105 (step S109). On the other hand, in the case where the relative start time of the r-th time unit is equal to or later than the relative viewing/listening end time (step S107: Yes route), it is judged that viewing/listening was carried out until the (r−1)-th time unit, and the audience number from the operation end time unit marked at the step S95 to the (r−1)-th time unit is increased by one, and is registered in the audience number table (step S111) In the case where the relative start time of the (r+1)-th time unit is equal to the relative viewing/listening end time, or in the case where the relative start time of the (r+1)-th time unit is later than the relative viewing/listening end time, since viewing/listening is ended in the r-th time unit, the step S107 proceeds to the step S109 until the relative start time of the (r+1)-th time unit is compared with the relative viewing/listening end time. Incidentally, even in the case where only s time units exist, the processing is carried out until a comparison with the start time of the (s+1)-th time unit (end time of the s-th time unit) is carried out. Then, the processing returns to the step S71 of FIG. 19 through terminal B.

In the case where it is judged at the step S99 that the final operation is not stop, the relative start time of a next operation is read (step S113). Then, the relative start time of the next operation is compared with the relative start time of the q-th (q is an integer and starts from the marked operation end time unit) time unit (step S115). In the case where the relative start time of the q-th time unit is earlier than the relative start time of the operation (step S117: No route), q is incremented by one, and the processing returns to the step S115 (step S119). On the other hand, in the case where the relative start time of the q-th time unit is equal to or later than the relative start time of the operation (step S117: Yes route), it is judged that the operation is started from the (q−1)-th time unit, and the audience number from the operation end time unit marked at the step S95 to the (q−1)-th time unit is increased by one (step S121). In the case where the relative start time of the (q+1)-th time unit is equal to the relative start time of the operation, or in the case where the relative start time of the (q+1)-th time unit is later than the relative start time of the operation, since viewing/listening is ended in the q-th time unit, the step S117 proceeds to the step S119 until the relative start time of the (q+1)-th time unit is compared with the relative start time of the operation. Incidentally, even in the case where only s time units exist, the processing is carried out until a comparison with the start time of the (s+1)-th time unit (end time of the s-th time unit) is carried out. Then, the processing returns to the step S89 through terminal A.

By carrying out the processing as described above, the policy of the audience number count as shown in FIG. 12 can be realized.

Incidentally, the embodiment of the present invention as described above is merely one example, and the invention is not limited to this. That is, the function block such as the audience rating calculation system 53 shown in FIG. 1 is an example, and does not necessarily become the same as an actual program module. Besides, the cooperation between the center station streaming delivery server 51 and the local station streaming delivery server 71 is not limited to the mode as described above, but may have any form as long as a delivery log is stored in each local station. Besides, the manner of storing the data in the audience rating calculation system 53 is not also limited to one shown in FIG. 1, since it is sufficient if similar data can be stored.

Besides, the Live audience number count processing shown in FIG. 11 is for embodying the audience number count policy shown in FIG. 10, and the VOD audience number count processing shown in FIGS. 19 and 20 is for embodying the audience number count policy shown in FIG. 12, and the audience number count policy can also be embodied by a different processing flow.

Besides, the audience number count policy itself is an example, and for example, according to FIG. 10, although the existence of viewing/listening in a time unit is judged according to whether viewing/listening is carried out even if only slightly, however, there can be such a policy that in the case where viewing/listening for a predetermined length can not be confirmed, viewing/listening is regarded as not having been carried out in the time unit. Besides, also with respect to the audience number count policy shown in FIG. 12, for example, like the fourth and sixth cases, not the audience number count manner in which an operation in the same time unit is neglected, but such a policy can be adopted that a repeated count is made in the case of rewind. In this case, it is appropriate to adopt such configuration that at the step S95 of FIG. 20, it is judged whether or not rewind is made, and if rewind is made, the (m−1)-th time unit is marked as the operation end time unit, and if fast forward is made, the m-th time unit is marked as the operation end time unit.

The sequence of the processing of the processing flow of FIG. 2 is not limited to FIG. 2, but it can be executed in an arbitrary sequence or in parallel.

Although the present invention has been described with respect to a specific preferred embodiment thereof, various change and modifications may be suggested to one skilled in the art, and it is intended that the present invention encompass such changes and modifications as fall within the scope of the appended claims.

What is claimed is:

1. A method for calculating a viewing/listening status index of a content delivered by streaming, said method comprising the steps of:
reading out log information concerning a content delivered by streaming to be processed in log information with respect to a content delivery processing by streaming, which is carried out in accordance with an instruction from each user terminal; and
extracting information concerning a time change of an audience number in said content delivered by streaming to be processed.

2. The method as set forth in claim 1, further comprising a step of calculating an audience rating by using the extracted information concerning said time change of said audience number in said content delivered by streaming to be processed.

3. The method as set forth in claim 1, wherein said extracting step comprises a step of analyzing details of said content delivery processing by streaming, which is carried out in accordance with an instruction from each user terminal, and information concerning a time associated with said content delivery processing, and specifying a repeatedly delivered portion and a non-delivered portion to each user terminal in said content delivered by streaming to be processed.

4. The method as set forth in claim 1, wherein said extracting step comprises a step of counting an audience number in each scene arbitrarily defined with respect to said content delivered by streaming to be processed by using the read log information.

5. The method as set forth in claim 1, wherein said step of reading out log information comprises a step of extracting log information with respect to a server for carrying out a content delivery processing for a specific area.

6. The method as set forth in claim 4, wherein said extracting step comprises a step of increasing an audience number for each scene from a scene including a viewing/listening start time to a scene including an viewing/listening end time in each log in a case where said content delivered by streaming to be processed is a live delivered content.

7. The method as set forth in claim 4, wherein, in a case where said content delivered by streaming to be processed is a content in a demand delivering mode, in said extracting step, a repeatedly delivered portion or a non-delivered portion in the same scene to one user terminal is left out of consideration in an audience number count of that scene.

8. The method as set forth in claim 4, wherein, in a case where said content delivered by streaming to be processed is a content in a demand delivering mode, in said extracting step, an audience number for all repeatedly delivered scenes is increased by a number of times of repeated delivery straddling scenes to one user terminal.

9. The method as set forth in claim 2, wherein said step of calculating an audience rating comprises a step of calculating an average audience rating with respect to said content delivered by streaming to be processed.

10. A program embodied on a medium, for causing a computer to calculate a viewing/listening status index of a content delivered by streaming, said program comprising the steps of:
reading out log information concerning a content delivered by streaming to be processed in log information with respect to a content delivery processing by streaming, which is carried out in accordance with an instruction from each user terminal; and
extracting information concerning a time change of an audience number in said content delivered by streaming to be processed.

11. The program as set forth in claim 10, further comprising a step of calculating an audience rating by using the extracted information concerning said time change of said audience number in said content delivered by streaming to be processed.

12. The program as set forth in claim 10, wherein said extracting step comprises a step of analyzing details of said content delivery processing by streaming, which is carried out in accordance with an instruction from each user terminal, and information concerning a time associated with said content delivery processing, and specifying a repeatedly delivered portion and a non-delivered portion to each user terminal in said content delivered by streaming to be processed.

13. The program as set forth in claim 10, wherein said extracting step comprises a step of counting an audience number in each scene arbitrarily defined with respect to said content delivered by streaming to be processed by using the read log information.

14. The program as set forth in claim 10, wherein said step of reading out log information comprises a step of extracting log information with respect to a server for carrying out a content delivery processing for a specific area.

15. The program as set forth in claim 13, wherein said extracting step comprises a step of increasing an audience number for each scene from a scene including a viewing/listening start time to a scene including an viewing/listening end time in each log in a case where said content delivered by streaming to be processed is a live delivered content.

16. The program as set forth in claim 13, wherein, in a case where said content delivered by streaming to be processed is a content in a demand delivering mode, in said extracting step, a repeatedly delivered portion or a non-delivered portion in the same scene to one user terminal is left out of consideration in an audience number count of that scene.

17. The program as set forth in claim 13, wherein, in a case where said content delivered by streaming to be processed is a content in a demand delivering mode, in said extracting step, an audience number for all repeatedly delivered scenes is increased by a number of times of repeated delivery straddling scenes to one user terminal.

18. The program as set forth in claim 11, wherein said step of calculating an audience rating comprises a step of calculating an average audience rating with respect to said content delivered by streaming to be processed.

19. An apparatus for calculating a viewing/listening status index of a content delivered by streaming, comprising:
means for reading out log information concerning a content delivered by streaming to be processed in log information with respect to a content delivery processing by streaming, which is carried out in accordance with an instruction from each user terminal; and
means for extracting information concerning a time change of an audience number in said content delivered by streaming to be processed.

20. The apparatus as set forth in claim 19, further comprising means for calculating an audience rating by using the extracted information concerning said time change of said audience number in said content delivered by streaming to be processed.

21. The apparatus as set forth in claim 19, wherein said means fro extracting comprises means for analyzing details of said content delivery processing by streaming, which is carried out in accordance with an instruction from each user terminal, and information concerning a time associated with said content delivery processing, and specifying a repeatedly delivered portion and a non-delivered portion to each user terminal in said content delivered by streaming to be processed.

22. The apparatus as set forth in claim 19, wherein said means for extracting comprises means for counting an audience number in each scene arbitrarily defined with respect to said content delivered by streaming to be processed by using the read log information.

23. The apparatus as set forth in claim 19, wherein said means for reading out log information comprises means for extracting log information with respect to a server for carrying out a content delivery processing for a specific area.

24. The apparatus as set forth in claim 22, wherein said means for extracting comprises means for increasing an audience number for each scene from a scene including a viewing/listening start time to a scene including an viewing/listening end time in each log in a case where said content delivered by streaming to be processed is a live delivered content.

25. The apparatus as set forth in claim 22, wherein, in a case where said content delivered by streaming to be processed is a content in a demand delivering mode, said means for extracting leaves a repeatedly delivered portion or a non-delivered portion in the same scene to one user terminal out of consideration in an audience number count of that scene.

26. The apparatus as set forth in claim 22, wherein, in a case where said content delivered by streaming to be processed is a content in a demand delivering mode, said means for extracting increases an audience number for all repeatedly delivered scenes by a number of times of repeated delivery straddling scenes to one user terminal.

27. The apparatus as set forth in claim 20, wherein said means for calculating an audience rating comprises means for calculating an average audience rating with respect to said content delivered by streaming to be processed.
